(19) United States
(12) Patent Application Publication
(10) Pub. No.: US 2024/0205121 A1
(43) Pub. Date: Jun. 20, 2024

(54) METHOD AND DEVICE USED FOR WIRELESS COMMUNICATION

(71) Applicants: Jinfang ZHANG, Shanghai (CN); Xiaobo ZHANG, Shanghai (CN)

(72) Inventors: Jinfang ZHANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/504,171

(22) Filed: Nov. 8, 2023

(30) Foreign Application Priority Data
Nov. 16, 2022 (CN) 202211432685.8

(51) Int. Cl. H04L 43/0811; H04W 76/20; H04W 80/02

(52) U.S. Cl. CPC H04L 43/0811; H04W 76/20; H04W 80/02

(57) ABSTRACT

The present application provides a method and device for wireless communications. A first node receives a first message, the first message is used to configure at least first RLC bearer; receives a second message, the second message indicates that the at least first RLC bearer is a candidate of multiple radio bearers; monitors whether any RLC bearer in multiple RLC bearers is failed, and the multiple RLC bearers are associated with the multiple radio bearers; as a response to monitoring failure of a second RLC bearer, transmits a first data unit set through the first RLC bearer, the first data unit set belongs to a first radio bearer; the second RLC bearer is associated with the first radio bearer, the first radio bearer is one of the multiple radio bearers. The present application can reduce RLC bearer space while reducing service interruption and improving transmission robustness.

### CROSS REFERENCE TO RELATED APPLICATIONS

This application claims the priority benefit of Chinese Patent Application No. 202211432685.8, filed on Nov. 16, 2022, the full disclosure of which is incorporated herein by reference.

### BACKGROUND

### Technical Field

The present application relates to methods and devices in wireless communication systems, and in particular to a method and device for supporting flexible configurations to improve transmission robustness in wireless communications.

### Related Art

Application scenarios of future wireless communication systems are becoming increasingly diversified, and different application scenarios have different performance demands on systems. To meet these various performance requirements, 3rd Generation Partner Project (3GPP) Radio Access Network (RAN) #72 Plenary decided to study New Radio (NR), or what is called the Fifth Generation (5G), and later at 3GPP RAN #75 Plenary, a Work Item (WI) was approved to standardize NR. The design of Release 15's 5G system has taken some major application scenarios into account. Subsequent versions will not only consider enhancements to 5G system architecture, but also further enhance vertical applications to provide more flexible service matching, more robust transmission, and more consistent user experience.

### SUMMARY

Inventors have found through researches that multipath transmission can effectively improve transmission robustness and reduce service interruption. However, adopting multipath configuration for all radio bearers will occupy a large amount of logical channel space, resulting in a waste in resources.

In response to the above issues, the present application discloses a solution that can achieve transmission robustness advantages while effectively reducing transmission path space and system complexity by flexibly configuring lower-layer transmission paths for radio bearers. If no conflict is incurred, embodiments in a first node in the present application and the characteristics of the embodiments are also applicable to a second node, and vice versa. And the embodiments in the present application and the characteristics in the embodiments can be arbitrarily combined if there is no conflict. Further, although the present application was originally intended for a Uu air interface, it can also be applied to a PC5 air interface. Further, although the present application is originally targeted at terminal and base station scenarios, it is also applicable to scenarios of relay and base station, where similar technical effects can be achieved. Additionally, the adoption of a unified solution for various scenarios, including but not limited to V2X scenarios and communication scenarios between terminals and base stations, contributes to the reduction of hardware complexity and costs. Particularly, for interpretations of the terminology, nouns, functions and variants (if not specified) in the present application, refer to definitions given in TS36 series, TS38 series and TS37 series of 3GPP specifications.

The present application provides a method in a first node for wireless communications, comprising:
receiving a first message, the first message being used to configure at least a first RLC bearer;
receiving a second message, the second message indicating that the at least first RLC bearer is a candidate of multiple radio bearers; monitoring whether any RLC bearer in multiple RLC bearers is failed, the multiple RLC bearers being associated with the multiple radio bearers; and
as a response to monitoring failure of a second RLC bearer, transmitting a first data unit set through the first RLC bearer, the first data unit set belonging to a first radio bearer; the second RLC bearer being associated with the first radio bearer, and the first radio bearer being one of the multiple radio bearers; the second RLC bearer being one of the multiple RLC bearers;
herein, the second message is an RRC-layer signaling; the first data unit set comprises at least one data unit.

In one embodiment, before monitoring second RLC bearer failure, the first Radio Link Control (RLC) bearer is not associated with any of the multiple radio bearers.

In one embodiment, before monitoring second RLC bearer failure, the first RLC bearer is pending.

In one embodiment, before monitoring second RLC bearer failure, the first RLC bearer is not activated.

In one embodiment, the multiple radio bearers have a same Quality of Service (QoS).

In one embodiment, the multiple radio bearers have different QoSs.

In one embodiment, the multiple radio bearers belong to a same type of radio bearer.

In one embodiment, an RLC bearer is a lower layer part of a radio carrier, comprising RLC and a Logical Channel (LCH).

In one embodiment, in the above method, configuring at least a first RLC bearer as a candidate of multiple radio bearers can reduce RLC bearer space, so as to reduce maintenance costs.

In one embodiment, the above method can effectively improve implementation flexibility.

In one embodiment, the above method can flexibly reconfigure a radio bearer.

In one embodiment, the above method can rapidly reconfigure a radio bearer.

In one embodiment, the above method effectively supports uplink transmission.

In one embodiment, the above method can rapidly switch RLC bearers, thus reducing interruption time during transmission, and improving transmission efficiency.

In one embodiment, the above method can avoid service interruption by continuing data transmission through a first RLC bearer after monitoring second RLC bearer failure.

In one embodiment, the above method can provide consistent user experience.

According to one aspect of the present application, comprising:
each data unit in the first data unit set being used to generate a MAC subPDU, the MAC subPDU comprising a MAC subheader, the MAC subheader comprising a first field, a second field and a third field, the first field indicating that there exists the second field, the second field indicating the first radio bearer; the third field indicating the first RLC bearer.

In one embodiment, the above method indicates that the first RLC bearer is associated with the first radio bearer at the MAC sublayer.

In one embodiment, the above method indicates that the first RLC bearer is associated with the first radio bearer on the user plane.

In one embodiment, the above method can implement rapid RLC bearer reconfiguration for radio bearers.

According to one aspect of the present application, comprising:
at least one of serving cells allowed by the first RLC bearer not belonging to serving cells allowed by the second RLC bearer;
herein, the first RLC bearer and the second RLC bearer belong to a same cell group.

In one embodiment, the above method can effectively utilize different radio resources.

According to one aspect of the present application, comprising:
the first RLC bearer and the second RLC bearer belonging to different cell groups.

In one embodiment, the above method can effectively utilize multiple radio resources.

According to one aspect of the present application, comprising:
transmitting a third message, the third message indicating the second RLC bearer failure;
herein, the third message is an RRC message.

According to one aspect of the present application, comprising:
the third message indicating the first RLC bearer.

In one embodiment, the above method, by indicating a first RLC bearer in an RRC message indicating second RLC bearer failure, can implicitly indicate that a first RLC bearer is associated with the first radio bearer.

According to one aspect of the present application, comprising:
receiving a fourth message, the fourth message confirming that the first RLC bearer is associated with the first radio bearer;
herein, the third message is used to trigger the fourth message; a transmission of the first data unit set is earlier than a reception of the fourth message.

In one embodiment, the association between the first RLC bearer and the first radio bearer is indicated at MAC sublayer only before receiving the fourth message.

In one embodiment, the above method can effectively avoid service interruption by continuously transmitting data before receiving the fourth message.

The present application provides a method in a second node for wireless communications, comprising:
transmitting a first message, the first message being used to configure at least a first RLC bearer; and
transmitting a second message, the second message indicating that the at least first RLC bearer is a candidate of multiple radio bearers;
herein, whether any RLC bearer in multiple RLC bearers is failed is monitored, and the multiple RLC bearers are associated with the multiple radio bearers; when second RLC bearer failure is monitored, a first data unit set is transmitted through the first RLC bearer, the first data unit set belongs to a first radio bearer; the second RLC bearer is associated with the first radio bearer, and the first radio bearer is one of the multiple radio bearers; the second RLC bearer is one of the multiple RLC bearers; the second message is an RRC-layer signaling; the first data unit set comprises at least one data unit.

According to one aspect of the present application, comprising:
each data unit in the first data unit set being used to generate a MAC subPDU, the MAC subPDU comprising a MAC subheader, the MAC subheader comprising a first field, a second field and a third field, the first field indicating that there exists the second field, the second field indicating the first radio bearer; the third field indicating the first RLC bearer.

According to one aspect of the present application, comprising:
at least one of serving cells allowed by the first RLC bearer not belonging to serving cells allowed by the second RLC bearer;
herein, the first RLC bearer and the second RLC bearer belong to a same cell group.

According to one aspect of the present application, comprising:
the first RLC bearer and the second RLC bearer belong to different cell groups.

According to one aspect of the present application, comprising:
receiving a third message, the third message indicating the second RLC bearer failure;
herein, the third message is an RRC message.

According to one aspect of the present application, comprising:

the third message indicating the first RLC bearer.

According to one aspect of the present application, comprising:
transmitting a fourth message, the fourth message confirming that the first RLC bearer is associated with the first radio bearer;
herein, the third message is used to trigger the fourth message; a reception of the first data unit set is earlier than a transmission of the fourth message.

The present application provides a first node for wireless communications, comprising:
a first receiver, receiving a first message, the first message being used to configure at least a first RLC bearer; receiving a second message, the second message indicating that the at least first RLC bearer is a candidate of multiple radio bearers; monitoring whether any RLC bearer in multiple RLC bearers is failed, the multiple RLC bearers being associated with the multiple radio bearers; and
a first processor, as a response to monitoring failure of a second RLC bearer, transmitting a first data unit set through the first RLC bearer, the first data unit set belonging to a first radio bearer; the second RLC bearer being associated with the first radio bearer, and the first radio bearer being one of the multiple radio bearers; the second RLC bearer being one of the multiple RLC bearers;
herein, the second message is an RRC-layer signaling; the first data unit set comprises at least one data unit.

The present application provides a second node for wireless communications, comprising:
a first transmitter, transmitting a first message, the first message being used to configure at least a first RLC bearer; transmitting a second message, the second message indicating that the at least first RLC bearer is a candidate of multiple radio bearers;
herein, whether any RLC bearer in multiple RLC bearers is failed is monitored, and the multiple RLC bearers are associated with the multiple radio bearers; when second RLC bearer failure is monitored, a first data unit set is transmitted through the first RLC bearer, the first data unit set belongs to a first radio bearer; the second RLC bearer is associated with the first radio bearer, and the first radio bearer is one of the multiple radio bearers; the second RLC bearer is one of the multiple RLC bearers; the second message is an RRC-layer signaling; the first data unit set comprises at least one data unit.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of signal transmission of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of hardware modules of a communication device according to one embodiment of the present application;

FIG. 5 illustrates a flowchart of radio signal transmission according to one embodiment of the present application;

FIG. 6 illustrates a schematic diagram of a first RLC bearer, a second RLC bearer and a first radio bearer according to one embodiment of the present application;

FIG. 7 illustrates another schematic diagram of a first RLC bearer, a second RLC bearer and a first radio bearer according to one embodiment of the present application;

FIG. 8 illustrates a schematic diagram of a first RLC bearer, a second RLC bearer, a first radio bearer, and a cell group according to one embodiment of the present application;

FIG. 9 illustrates a schematic diagram of a format a MAC subheader according to one embodiment of the present application;

FIG. 10 illustrates a structure block diagram of a processor in a first node according to one embodiment of the present application;

FIG. 11 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

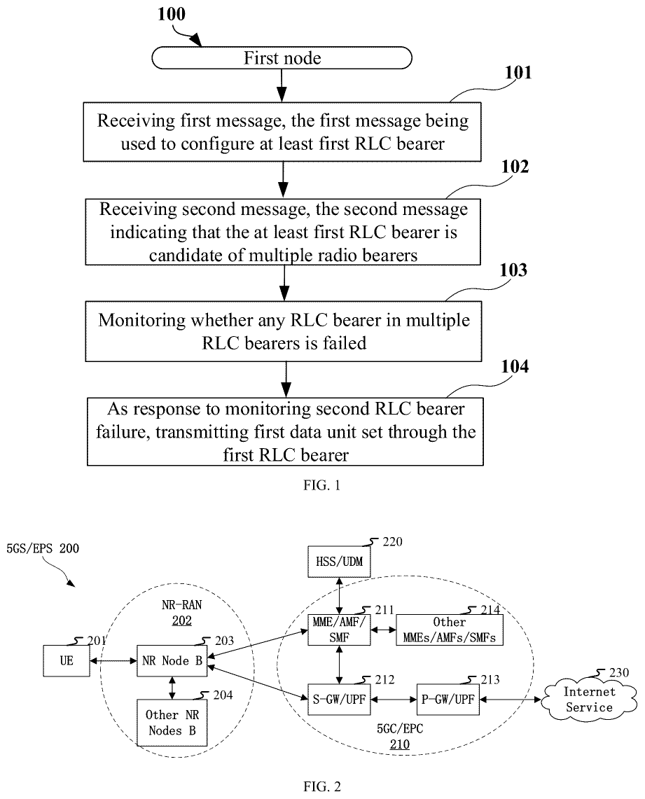

Embodiment 1 illustrates a flowchart of signal transmission of a first node according to one embodiment of the present application, as shown in FIG. 1.

In embodiment 1, a first node 100 receives a first message, the first message is used to configure at least one first RLC bearer; receives a second message in step 102, the second message indicates that the at least first RLC bearer is a candidate of multiple radio bearers; in step 103, monitors whether any RLC bearer in multiple RLC bearers is failed, and the multiple RLC bearers are associated with the multiple radio bearers; in step 104, as a response to monitoring second RLC bearer failure, transmits a first data unit set through the first RLC bearer, the first data unit set belongs to a first radio bearer, the second RLC bearer is associated with the first radio bearer, the first radio bearer is one of the multiple radio bearers, and the second RLC bearer is one of the multiple RLC bearers; herein, the second message is an RRC-layer signaling; the first data unit set comprises at least one data unit.

In one embodiment, a first message is received via an air interface.

In one embodiment, the air interface is a Uu air interface.

In one embodiment, the radio interface is a PC5 air interface.

In one embodiment, the first message is a higher-layer message.

In one embodiment, the first message is a Radio Resource Control (RRC) signaling.

In one embodiment, the first message is comprised in a CellGroupConfig message.

In one embodiment, the first message comprises all or partial Information Elements (IEs) in an RRC signaling.

In one embodiment, the first message comprises all or partial fields in an IE in an RRC signaling.

In one embodiment, the first message is an IE in a Cell Group (CG) configuration.

In one embodiment, the first message is used to configure at least one first RLC bearer.

In one embodiment, the at least first RLC bearer only comprises a first RLC bearer.

In one embodiment, the at least first RLC bearer comprises multiple RLC bearers, and the first RLC bearer is one of the multiple RLC bearers.

In one embodiment, the first message is comprised in an rlc-BearerToAddModList message.

In one embodiment, the first message is RLC-BearerConfig.

In one embodiment, the first message comprises a configuration of the at least first RLC bearer.

In one embodiment, a configuration of an RLC bearer comprises a lower layer part of radio bearer configuration, comprising RLC and logical channel configuration.

In one embodiment, the configuration of at least a first RLC bearer comprises a configuration of at least a first logical channel, the at least first logical channel respectively corresponds to the at least first RLC bearer, both the at least first logical channel and the at least first RLC bearer are identified by at least a first logical channel identifier (LCID), and the configuration of the at least first RLC bearer comprises the at least first logical channel identifier.

In one embodiment, the configuration of at least the first logical channel comprises a priority of at least the first logical channel.

In one embodiment, the configuration of at least the first RLC bearer comprises a configuration of at least a first RLC entity, the at least first RLC entity respectively corresponds to the at least first RLC bearer, and the at least first RLC entity is used to transmit a data unit of at least the first RLC bearer.

In one embodiment, the configuration of the at least first RLC entity comprises a working mode of the at least first RLC entity.

In one embodiment, each logical channel in at least the first logical channel is associated with one RLC entity in at least the first RLC entity.

In one embodiment, the meaning of a logical channel being associated with an RLC entity is: an RLC entity transmits data to or receives data from lower layer through a logical channel.

In one embodiment, a second message is received through the air interface.

In one embodiment, the second message is a higher-layer message.

In one embodiment, the second message is a Radio Resource Control (RRC) signaling.

In one embodiment, the second message is comprised in a CellGroupConfig message.

In one embodiment, the second message comprises all or partial IEs in an RRC signaling.

In one embodiment, the second message comprises all or partial fields in an IE in an RRC signaling.

In one embodiment, the second message is an IE in a Cell Group (CG) configuration.

In one embodiment, both the first message and the second message belong to an RRC signaling.

In one embodiment, the first message and the second message belong to two IEs in a same RRC signaling.

In one embodiment, the first message and the second message belong to two fields in an IE in a same RRC signaling.

In one embodiment, the second message indicates that the at least first RLC bearer is a candidate of multiple radio bearers.

In one embodiment, a name of the second message comprises reserved.

In one embodiment, a name of the second message comprises candidate.

In one embodiment, a name of the second message comprises reservedRLCBearer-Config.

In one embodiment, a name of the second message comprises candidateRLCBearer-Config.

In one embodiment, the second message comprises the at least first logical channel identifier, and each logical channel identifier in the at least first logical channel identifier is used to identify one RLC bearer in the at least first RLC bearer.

In one embodiment, the second message comprises multiple radio bearer identifiers, and each of the multiple radio bearer identifiers is used to identify one of the multiple radio bearers.

In one embodiment, the multiple radio bearer identifiers are used to identify the multiple radio bearers, and the multiple radio bearer identifiers respectively correspond to the multiple radio bearers.

In one embodiment, the second message comprises a CandidateRadioBearer field, and the CandidateRadioBearer comprises the multiple radio bearer identifiers.

In one embodiment, the multiple radio bearers comprise a Data Radio Bearer (DRB).

In one embodiment, the multiple radio bearers comprise an NIBS radio bearer (MRB).

In one embodiment, the multiple radio bearers comprise a multicast MRB.

In one embodiment, the multiple radio bearers comprise a Signaling Radio Bearer (SRB).

In one embodiment, the multiple radio bearers belong to a same type of radio bearer.

In one embodiment, the multiple radio bearers belong to a same Protocol Data Unit (PDU) session.

In one embodiment, the multiple radio bearers belong to different PDU sessions.

In one embodiment, the multiple radio bearers belong to different PDU sets.

In one embodiment, the different PDU sets belong to a same application.

In one embodiment, the different PDU sets belong to a same session.

In one embodiment, the phrase that the at least first RLC bearer is a candidate of multiple radio bearers comprises: the at least first RLC bearer is only used for lower-layer transmission of the multiple radio bearers (when failure of an RLC bearer associated with the multiple radio bearer is monitored).

In one embodiment, the phrase that the at least first RLC bearer is a candidate of multiple radio bearers comprises: the at least first RLC bearer cannot be used for lower-layer transmission of a radio bearer other than the multiple radio bearers.

In one embodiment, the phrase that the at least first RLC bearer is a candidate of multiple radio bearers comprises: the at least first RLC bearer is only associated (when failure of any RLC bearer associated with the multiple radio bearers is monitored) with one radio bearer associated with a corresponding failed RLC bearer among the multiple radio bearers.

In one embodiment, the phrase that the at least first RLC bearer is a candidate of multiple radio bearers comprises: the at least first RLC bearer cannot be associated with a radio bearer other than the multiple radio bearers.

In one embodiment, the phrase that the at least first RLC bearer is a candidate of multiple radio bearers comprises: when no failure of any RLC bearer associated with the multiple radio bearers is monitored, the at least first RLC bearer is in a deactivation state.

In one embodiment, the phrase that the at least first RLC bearer is a candidate of multiple radio bearers comprises: when no failure of any RLC bearer associated with the multiple radio bearers is monitored, the at least first RLC bearer is not associated with any radio bearer.

In one embodiment, whether any RLC bearer in multiple RLC bearers is failed is monitored, and the multiple RLC bearers are associated with the multiple radio bearers.

In one embodiment, monitoring RLC bearer failure comprises: monitoring that timer T310 expires.

In one embodiment, monitoring RLC bearer failure comprises: receiving random access problem indication from MAC layer.

In one embodiment, monitoring RLC bearer failure comprises: receiving an indication of reaching a maximum number of retransmission(s) from an RLC entity.

In one embodiment, an RLC bearer is a lower layer part of a radio bearer.

In one embodiment, an RLC bearer comprises an RLC entity and a logical channel.

In one embodiment, when an RLC entity indicating to an RRC sublayer reaching a maximum number of retransmission(s) is monitored, the RLC bearer failure is monitored.

In one embodiment, a transmitting side of an RLC entity counts a number of retransmission(s) of each RLC packet; when a maximum number of retransmission(s) is reached, it indicates to an RRC sublayer.

In one embodiment, when the transmitting side of an RLC entity receives a NACK indication of an RLC packet and deems that it is necessary to retransmit, it increases a number of retransmission(s) of the RLC packet by 1.

In one embodiment, the RLC data packet is an RLC SDU or an RLC SDU segment.

In one embodiment, the multiple RLC bearers being associated with the multiple radio bearers comprises: each RLC bearer in the multiple RLC bearers is associated with one of the multiple radio bearers.

In one embodiment, each radio bearer in the multiple radio bearers is only associated with one of the multiple RLC bearers.

In one embodiment, as a response to monitoring failure of a second RLC bearer, a first data unit set is transmitted through the first RLC bearer, and the first data unit set belongs to a first radio bearer.

In one subembodiment of the above embodiment, stop transmitting the first data unit set through the second RLC bearer.

In one subembodiment of the above embodiment, the first RLC bearer is associated with the first radio bearer.

In one subembodiment of the above embodiment, the at least first RLC bearer is associated with the first radio bearer.

In one subembodiment of the above embodiment, the at least first RLC bearer is associated with the first radio bearer and the first RLC bearer is activated.

In one embodiment, the first RLC bearer is an RLC bearer corresponding to a logical channel with a smallest logical channel identifier in at least the first RLC bearer.

In one embodiment, the first RLC bearer is an RLC bearer corresponding to a logical channel with a largest logical channel identifier in at least the first RLC bearer.

In one embodiment, the first RLC bearer is an RLC bearer corresponding to a reference logical channel in the at least first RLC bearer, and an RLC bearer corresponding to the reference logical channel belongs to the at least first RLC bearer, and the reference logical channel is indicated by the second message.

In one embodiment, upon monitoring failure of the second RLC bearer, the first RLC bearer is not associated with any of the multiple radio bearers.

In one embodiment, the second RLC bearer is associated the first radio bearer.

In one embodiment, before monitoring failure of the second RLC bearer, a data unit of the first radio bearer is transmitted through the second RLC bearer.

In one embodiment, the second RLC bearer is one of the multiple RLC bearers.

In one embodiment, a first radio bearer identifier is used to identify the first radio bearer.

In one embodiment, the first radio bearer is one of the multiple radio bearers, and the first radio bearer identifier is one of the multiple radio bearer identifiers.

In one embodiment, when an RLC bearer is configured to serve a radio bearer, the RLC bearer is associated with the radio bearer.

In one embodiment, when a radio bearer is configured to transmit through an RLC bearer at lower layer, the RLC bearer is associated with the radio bearer.

In one embodiment, the lower layer comprises an RLC sublayer.

In one embodiment, the lower layer comprises a logical channel.

In one embodiment, the lower layer comprises an MAC sublayer.

In one embodiment, when an RLC entity is activated, an RLC bearer comprising the RLC entity is activated.

In one embodiment, the first data unit set belongs to the first radio bearer.

In one embodiment, the first data unit set comprises at least one data unit.

In one embodiment, the transmission comprises at least one of transmitting or receiving.

In one embodiment, a data unit on downlink processed by the RLC entity corresponding to the first RLC bearer is submitted to a PDCP entity of the first radio bearer.

In one subembodiment of the above embodiment, the PDCP entity is a receiving PDCP entity.

In one embodiment, a data unit on uplink processed by a PDCP entity of the first radio bearer is submitted to an RLC entity corresponding to the first RLC bearer.

In one subembodiment of the above embodiment, the PDCP entity is a transmitting PDCP entity.

In one embodiment, the first data unit set comprises an Internet Protocol (IP) data packet.

In one embodiment, the first data unit set comprises a Non-access layer (NAS) control message.

In one embodiment, the first data unit set comprises an RRC signaling.

In one embodiment, the first data unit set comprises a Service Data Unit (SDU).

In one embodiment, the first data unit set comprises a PDCP PDU.

### Embodiment 2

Embodiment 2 illustrates a schematic diagram of a network architecture according to one embodiment of the present application, as shown in FIG. 2. FIG. 2 is a diagram illustrating a network architecture 200 of 5G NR, Long-Term Evolution (LTE), and Long-Term Evolution Advanced (LTE-A) systems. The NR 5G, LTE or LTE-A network architecture 200 may be called a 5G System (5GS)/Evolved Packet System (EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). XnAP protocol of Xn interface is used to transmit control plane messages of wireless networks, and user plane protocol of Xn interface is used to transmit user plane data. The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms, and in Non Terrestrial Networks (NTNs), the gNB 203 can be a satellite, an aircraft or a terrestrial base station relayed through a satellite. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, vehicle equipment, On-board communication unit, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the gNB 203 corresponds to the second node in the present application.

In one embodiment, the UE 201 is a UE.

In one embodiment, the UE 201 is a layer-2 U2N remote UE.

In one embodiment, the gNB 203 is a Marco Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the gNB 203 is a testing device (e.g., a transceiver device simulating partial functions of a base station, a signaling tester).

In one embodiment, a radio link from the UE 201 to the gNB 203 is an uplink, and the uplink is used for executing an uplink transmission.

In one embodiment, a radio link from the gNB 203 to the UE 201 is a downlink, and the downlink is used for executing a downlink transmission.

In one embodiment, the UE 201 and the gNB 203 are connected via a Uu air interface.

### Embodiment 3

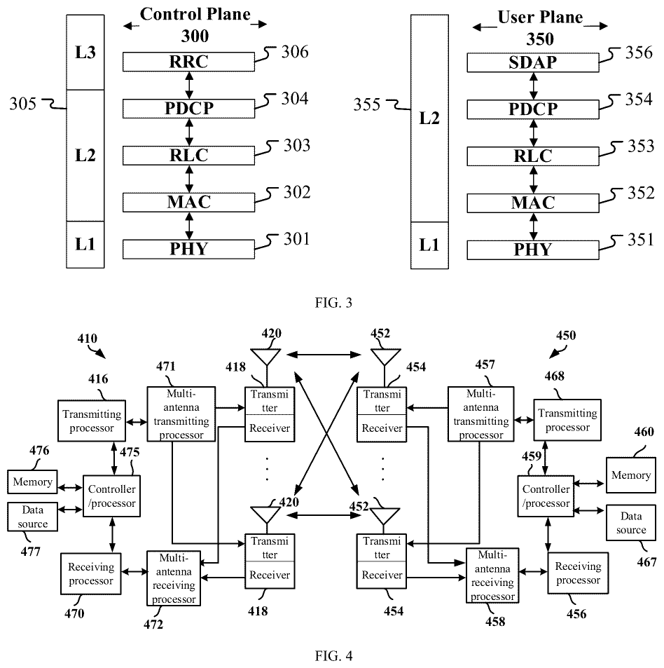

Embodiment 3 illustrates a schematic diagram of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 of a UE and a gNB is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the UE and the gNB via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection and also provides support for a UE handover between gNBs. The RLC sublayer 303 provides packet segmentation and reassembly, and achieves retransmission of lost packets through Automatic Repeat Request (ARQ). The RLC sublayer 303 also provides repeat packet detection and protocol error detection. The MAC sublayer 302 provides mapping between a logic channel and a transport channel and multiplexing of the logical channel. The MAC sublayer 302 is also responsible for allocating between UEs various radio resources (i.e., resources block) in a cell. The MAC sublayer 302 is also responsible for Hybrid Automatic Repeat Request (HARQ) operation. The Radio Resource Control (RRC) sublayer 306 in layer 3 (L3) of the control plane 300 is responsible for acquiring radio resources (i.e., radio bearer) and configuring the lower layer with an RRC signaling between the gNB and the UE. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. The radio protocol architecture of the UE in the user plane 350 may comprises part or all of protocol sublayers of the SDAP sublayer 356, the PDCP sublayer 354, the RLC sublayer 353 and the MAC sublayer 352 at L2 layer. Although not described in FIG. 3, the UE may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the RLC 303 transmits data to the MAC 302 or receives data from the MAC 302 through a logical channel.

In one embodiment, the RLC 353 transmits data to the MAC 352 or receives data from the MAC 352 through a logical channel.

In one embodiment, a logical channel for communications between the RLC 303 and the MAC 302 constitutes an RLC bearer.

In one embodiment, a logical channel for communications between the RLC 353 and the MAC 352 constitutes an RLC bearer.

In one embodiment, entities of multiple sublayers of the control plane in FIG. 3 form an SRB in the vertical direction.

In one embodiment, entities of multiple sublayers of the user plane in FIG. 3 form a DRB in the vertical direction.

In one embodiment, entities of multiple sublayers of the user plane in FIG. 3 form an MRB in the vertical direction.

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the RRC 306.

In one embodiment, the second message in the present application is generated by the RRC 306.

In one embodiment, the third message in the present application is generated by the RRC 306.

In one embodiment, the third message in the present application is generated by the MAC 302 or MAC 352.

In one embodiment, the fourth message in the present application is generated by the RRC 306.

In one embodiment, the fourth message in the present application is generated by the MAC 302 or MAC 352.

In one embodiment, the fourth message in the present application is generated by the PHY 301 or PHY 351.

In one embodiment, the first data unit set in the present application is generated by the PDCP 304 or the PDCP 354.

In one embodiment, the L2 layer 305 or 355 belongs to a higher layer.

In one embodiment, the RRC sublayer 306 in the L3 layer belongs to a higher layer.

### Embodiment 4

Embodiment 4 illustrates a schematic diagram of hardware modules of a communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a data source 477, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from the core network or a higher layer packet from the data source 477 is provided to the controller/processor 475. The core network and the data source 477 represents all protocol layers above the L2 layer. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. The data and the control signal are then provided to the controller/processor 440. The controller/processor 440 implements functions of L2 layer. The controller/processor 475 can be connected with the memory 476 that stores program code and data. The memory 460 can be called a computer readable medium. In a transmission from the second communication device 410 to the first communication device 450, the controller/processor 459 provides multiplexing between a transport channel and a logical channel, packet reassembling, decryption, header decompression, control signal processing so as to recover a higher-layer packet from the second communication device 410. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 475 is also responsible for retransmission of a lost packet and a signaling to the second communication device 450. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides a function of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the first communication device 450. The higher layer packet from the controller/processor 475 can be provided to all protocol layers above the core network or the L2 layer, and various control signals can also be provided to the core network or L3 layer for L3 layer processing.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first message, the first message is used to configure at least first RLC bearer; receives a second message, the second message indicates that the at least first RLC bearer is a candidate of multiple radio bearers; monitors whether any RLC bearer in multiple RLC bearers is failed, and the multiple RLC bearers are associated with the multiple radio bearers; as a response to monitoring failure of a second RLC bearer, transmits a first data unit set through the first RLC bearer, the first data unit set belongs to a first radio bearer; the second RLC bearer is associated with the first radio bearer, the first radio bearer is one of the multiple radio bearers; the second RLC bearer is one of the multiple RLC bearers; herein, the second message is an RRC-layer signaling, and the first data unit set comprises at least one data unit.

In one embodiment, the first communication device 450 comprises: a memory that stores a computer readable instruction program. The computer readable instruction program generates an action when executed by at least one processor. The action includes: receiving a first message, the first message being used to configure at least a first RLC bearer; receiving a second message, the second message indicating that the at least first RLC bearer is a candidate of multiple radio bearers; monitoring whether any RLC bearer in multiple RLC bearers is failed, the multiple RLC bearers being associated with the multiple radio bearers; as a response to monitoring failure of a second RLC bearer, transmitting a first data unit set through the first RLC bearer, the first data unit set belonging to a first radio bearer; the second RLC bearer being associated with the first radio bearer, and the first radio bearer being one of the multiple radio bearers; the second RLC bearer being one of the multiple RLC bearers; herein, the second message is an RRC-layer signaling, and the first data unit set comprises at least one data unit.

In one embodiment, the second communication device 410 comprises at least one processor and at least one memory. The at least one memory comprises computer program codes; the at least one memory and the computer program codes are configured to be used in collaboration with the at least one processor, the second communication device 410 at least: transmits a first message, the first message is used to configure at least first RLC bearer; transmits a second message, the second message indicates that the at least first RLC bearer is a candidate of multiple radio bearers; herein, whether any RLC bearer in multiple RLC bearers is failed is monitored, and the multiple RLC bearers are associated with the multiple radio bearers; when second RLC bearer failure is monitored, a first data unit set is transmitted through the first RLC bearer, the first data unit set belongs to a first radio bearer; the second RLC bearer is associated with the first radio bearer, and the first radio bearer is one of the multiple radio bearers; the second RLC bearer is one of the multiple RLC bearers; the second message is an RRC-layer signaling; the first data unit set comprises at least one data unit.

In one embodiment, the second communication device 410 comprises a memory that stores a computer readable instruction program. The computer readable instruction program generates an action when executed by at least one processor. The action includes: transmitting a first message, the first message being used to configure at least a first RLC bearer; transmitting a second message, the second message indicating that the at least first RLC bearer is a candidate of multiple radio bearers; herein, whether any RLC bearer in multiple RLC bearers is failed is monitored, and the multiple RLC bearers are associated with the multiple radio bearers; when second RLC bearer failure is monitored, a first data unit set is transmitted through the first RLC bearer, the first data unit set belongs to a first radio bearer; the second RLC bearer is associated with the first radio bearer, and the first radio bearer is one of the multiple radio bearers; the second RLC bearer is one of the multiple RLC bearers; the second message is an RRC-layer signaling; the first data unit set comprises at least one data unit.

In one embodiment, the second communication device 450 corresponds to a first node in the present application.

In one embodiment, the second communication device 410 corresponds to a second node in the present application.

In one embodiment, the first communication device 450 is a UE.

In one embodiment, the first communication device 450 is a layer 2 U2N remote UE.

In one embodiment, the first communication device 450 is a layer 3 relay node.

In one embodiment, the second communication device 410 is a base station.

In one embodiment, at least one of the antenna 420, the transmitter 418, the multi-antenna transmitting processor 471, the transmitting processor 416 or the controller/processor 475 is used to transmit a first message in the present application.

In one embodiment, at least one of the antenna 452, the receiver 454, the multi-antenna receiving processor 458, the receiving processor 456 or the controller/processor 459 is used to receive a first message in the present application.

In one embodiment, at least one of the antenna 420, the transmitter 418, the multi-antenna transmitting processor 471, the transmitting processor 416 or the controller/processor 475 is used to transmit a second message in the present application.

In one embodiment, at least one of the antenna 452, the receiver 454, the multi-antenna receiving processor 458, the receiving processor 456 or the controller/processor 459 is used to receive a second message in the present application.

In one embodiment, at least one of the antenna 452, the transmitter 454, the multi-antenna transmitting processor 457, the transmitting processor 468 or the controller/processor 459 is used to transmit a third message in the present application.

In one embodiment, at least one of the antenna 420, the receiver 418, the multi-antenna receiving processor 472, the receiving processor 470 or the controller/processor 475 is used to receive a third message in the present application.

In one embodiment, at least one of the antenna 420, the transmitter 418, the multi-antenna transmitting processor 471, the transmitting processor 416 or the controller/processor 475 is used to transmit a fourth message in the present application.

In one embodiment, at least one of the antenna 452, the receiver 454, the multi-antenna receiving processor 458, the receiving processor 456 or the controller/processor 459 is used to receive a fourth message in the present application.

In one embodiment, at least one of the antenna 452, the transmitter 454, the multi-antenna transmitting processor 457, the transmitting processor 468 or the controller/processor 459 is used to transmit a first data unit set in the present application.

In one embodiment, at least one of the antenna 452, the receiver 454, the multi-antenna receiving processor 458, the receiving processor 456 or the controller/processor 459 is used to receive a first data unit set in the present application.

In one embodiment, at least one of the antenna 420, the receiver 418, the multi-antenna receiving processor 472, the receiving processor 470 or the controller/processor 475 is used to receive a first data unit set in the present application.

In one embodiment, at least one of the antenna 420, the transmitter 418, the multi-antenna transmitting processor 471, the transmitting processor 416 or the controller/processor 475 is used to transmit a first data unit set in the present application.

### Embodiment 5

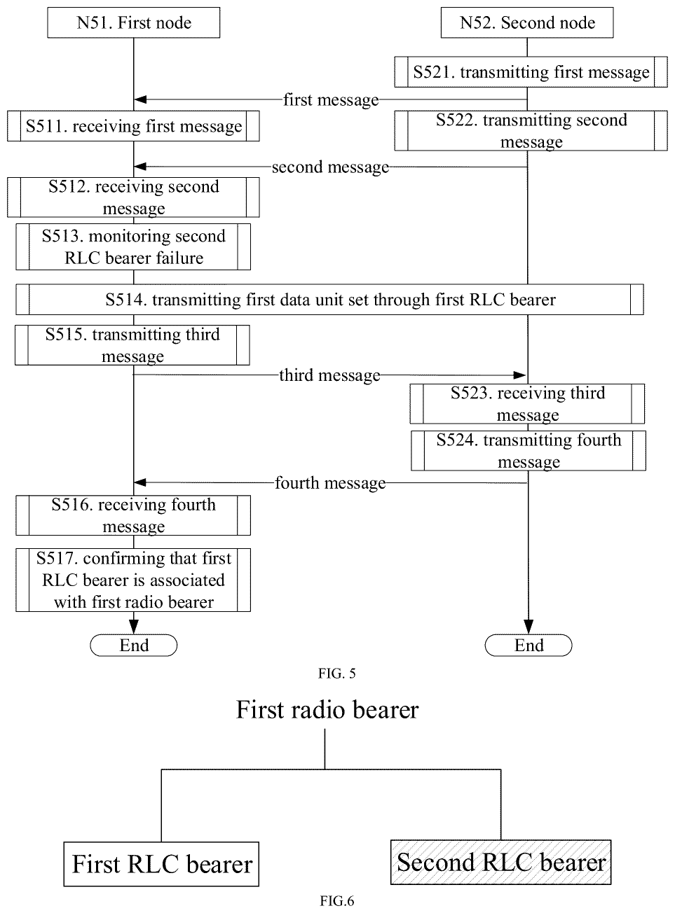

Embodiment 5 illustrates a flowchart of radio signal transmission according to one embodiment in the present application, as shown in FIG. 5. In FIG. 5, a first node N51 and a second node N52 are in communications via an air interface. It is particularly underlined that the order illustrated in the embodiment does not put constraints over sequences of signal transmissions and implementations.

The first node N51 receives a first message in step S511; receives a second message in step S512; monitors second RLC bearer failure in step S513; transmits a first data unit set through a first RLC bearer in step S514; transmits a third message in step S515; receives a fourth message in step S516; confirms that a first RLC bearer is associated with a first radio bearer in step S517.

The second node N52 transmits a first message in step S521; transmits a second message in step S522; receives a third message in step S523; transmits a fourth message in step S524.

It should be noted that the step S514 comprises communications between the first node N51 and the second node N52.

It should be noted that an execution sequence of the step S515 and the step S514 is only an example and not limited; the step S515 can be executed earlier than the step S514, or when the step S514 comprises multiple data unit transmissions, an execution order of the step S515 can be earlier than the transmission of partial data units comprised in the step S514.

In embodiment 5, receive a first message, the first message is used to configure at least first RLC bearer; receive a second message, the second message indicates that the at least first RLC bearer is a candidate of multiple radio bearers; herein, the second message is an RRC-layer signaling; monitor whether any RLC bearer in multiple RLC bearers is failed, the multiple RLC bearers are associated with the multiple radio bearers; as a response to monitoring failure of a second RLC bearer, transmit a first data unit set through the first RLC bearer, the first data unit set belongs to a first radio bearer, and the first data unit set comprises at least one data unit; transmit a third message, the third message indicates the second RLC bearer failure; the third message indicates the first RLC bearer; herein, the third message is an RRC message; receive a fourth message, the fourth message confirms that the first RLC bearer is associated with the first radio bearer; herein, the third message is used to trigger the fourth message; a transmission of the first data unit set is earlier than a reception of the fourth message.

In one embodiment, the second node N52 is a maintenance base station for a serving cell of the first node N51.

In one embodiment, the second node N52 is a Transmit/Receive Point (TRP) of a serving cell of the first node N51.

In one embodiment, the second node N52 is a maintenance base station of a master cell group (MCG) of the first node N51.

In one embodiment, the second node N52 is a maintenance base station of a Secondary cell group (SCG) of the first node N51.

In one embodiment, the second node N52 is a maintenance base station of a primary cell of the first node N51.

In one embodiment, the second node N52 is a maintenance base station of a secondary cell of the first node N51.

In one embodiment, the second node N52 is a maintenance base station of a special cell (SpCell) of the first node N51.

In one embodiment, the third message indicates that the first RLC bearer is associated with the first radio bearer.

In one embodiment, the phrase that the first RLC bearer is associated with the first radio bearer comprises: the first RLC bearer is associated with the first radio bearer and is activated.

In one embodiment, the third message comprises a first radio bearer identifier, and the first radio bearer identifier is used to identify the first radio bearer.

In one embodiment, the third message comprises the first logical channel identifier and a first radio bearer identifier, and the first logical channel identifier is used to identify the first RLC bearer; the first radio bearer identifier is used to identify the first radio bearer.

In one embodiment, the third message is higher layer.

In one embodiment, the third message is an RRC-layer message.

In one embodiment, the third message comprises all or partial IEs in an RRC signaling.

In one embodiment, the third message comprises all or partial fields in an IE in an RRC signaling.

In one embodiment, the third message is used to indicate UE assistance information to the network.

In one embodiment, the third message is UEAssistanceInformation.

In one embodiment, the third message is used to indicate a failure message to the network.

In one embodiment, the third message is used to indicate an RLC failure message to the network.

In one embodiment, the third message is FailureInformation.

In one embodiment, the third message is MCGFailureInformation.

In one embodiment, the third message is SCGFailureInformation.

In one embodiment, the third message comprises the first radio bearer identifier.

In one embodiment, the third message indicates the second RLC bearer failure.

In one embodiment, the second RLC bearer failure is not used to trigger Radio Link Failure (RLF).

In one embodiment, the third message is transmitted through SRB1.

In one embodiment, the third message is transmitted through SRB3.

In one embodiment, the first processor, as a response to monitoring second RLC bearer failure, activates a split signaling radio bearer.

In one embodiment, the third message is transmitted through a split signaling radio bearer.

In one embodiment, the third message is transmitted through split SRB1.

In one embodiment, the third message comprises a second RLC bearer identifier, and the second RLC bearer identifier is used to identify the second RLC bearer.

In one embodiment, the third message comprises a second RLC bearer identifier and a first radio bearer identifier, the second RLC bearer identifier is used to identify the second RLC bearer, and the first radio bearer identifier is used to identify the first radio bearer.

In one embodiment, the first processor transmits a third message, the third message indicates the second RLC bearer failure; herein, the third message is a MAC sub-layer message.

In one embodiment, the third message is MAC CE(s).

In one embodiment, an RLC mode used by the first RLC bearer is the same as an RLC mode used by the second RLC bearer.

In one embodiment, the RLC mode comprises UL (uplink) RLC or DL (downlink) RLC.

In one embodiment, the RLC mode comprises one of three modes: Acknowledged Mode (AM) RLC, Unacknowledged Mode (UM) RLC, or Transparent Mode (TM) RLC.

In one embodiment, an RLC mode used by the first RLC bearer is different from an RLC mode used by the second RLC bearer.

In one embodiment, a configuration of the first RLC bearer is the same as a configuration of the second RLC bearer.

In one embodiment, the first RLC bearer and the second RLC bearer have a same priority.

In one embodiment, the first RLC bearer and the second RLC bearer have different priorities.

In one embodiment, the first RLC bearer and the second RLC bearer have different allowed serving cells.

In one subembodiment of the above embodiment, an allowed serving cell of the second RLC bearer is a primary serving cell, and an allowed serving cell of the first RLC bearer is a secondary serving cell.

In one subembodiment of the above embodiment, an allowed serving cell of the second RLC bearer is a secondary serving cell, and an allowed serving cell of the first RLC bearer is a primary serving cell.

In one subembodiment of the above embodiment, an allowed serving cell of the second RLC bearer belongs to a primary serving cell group, and an allowed serving cell of the first RLC bearer belongs to a secondary serving cell group.

In one subembodiment of the above embodiment, an allowed serving cell of the second RLC bearer belongs to a secondary serving cell group, and an allowed serving cell of the first RLC bearer belongs to a primary serving cell group.

In one embodiment, upon monitoring the second RLC bearer failure, the first radio bearer is not configured a PDCP duplication and is not configured a split bearer.

In one embodiment, upon monitoring failure of the second RLC bearer, the first radio bearer is only associated with the second RLC bearer.

In one embodiment, upon monitoring failure of the second RLC bearer, a data unit of the first radio bearer is transmitted only through the second RLC bearer.

In one embodiment, upon monitoring failure of the second RLC bearer, the first radio bearer only has one primary path for transmission.

In one embodiment, the PDCP repetition is a Carrier Aggregation (CA) duplication.

In one embodiment, upon monitoring failure of the second RLC bearer, the first radio bearer is configured PDCP duplication and the PDCP duplication is not activated.

In one embodiment, upon monitoring failure of the second RLC bearer, the first radio bearer is configured a split bearer and a bearer transmitted through an SCG is not activated.

In one embodiment, the fourth message confirms that the first RLC bearer is associated with the first radio bearer.

In one embodiment, the first processor receives the fourth message and then confirms that the first RLC bearer is associated with the first radio bearer.

In one embodiment, the fourth message is an RRC signaling.

In one embodiment, the fourth message is an RRCReconfiguration message.

In one embodiment, the fourth message is a MAC sublayer signaling.

In one embodiment, the fourth message is a MAC CE.

In one subembodiment of the above embodiment, the fourth message is identified by a logical channel identifier, and an index of the logical channel identifier is a value between 35 and 46, comprising 35 and 46.

In one subembodiment of the above embodiment, the fourth message is identified by a logical channel identifier, and an index of the logical channel identifier is a value between 64 and 290, comprising 64 and 290.

In one embodiment, the fourth message comprises the first logical channel identifier and the first radio bearer identifier.

In one embodiment, the first logical channel identifier is used to identify the first RLC bearer.

In one embodiment, the fourth message is a MAC subPDU, and a MAC subheader comprised in the MAC subPDU indicates the first RLC bearer; herein, a logical channel identifier of the first RLC bearer is indicated to be reserved.

In one subembodiment of the above embodiment, a MAC SDU comprised in the MAC subPDU belongs to the first radio bearer.

In one embodiment, the phrase that a logical channel identifier of the first RLC bearer is indicated to be reserved comprises: a logical channel identifier indicating the first RLC bearer is different from a logical channel identifier of an RLC bearer indicating all radio bearers associated with the first node.

In one embodiment, the fourth message is a MAC subPDU, and a format of a MAC subheader comprised in the MAC subPDU is the same as a format of a MAC subheader comprised in a MAC subPDU generated by the first data unit set.

In one embodiment, the fourth message is a MAC subPDU, and a MAC subheader comprised in the MAC subPDU indicates the first RLC bearer and the first radio bearer, and a MAC SDU comprised in the MAC subPDU belongs to the first radio bearer.

In one embodiment, the fourth message is a PHY-layer signaling.

In one embodiment, the third message is used to trigger the fourth message.

In one embodiment, the fourth message is a response to the third message.

In one embodiment, a transmission of the first data unit set is earlier than a reception of the fourth message.

In one embodiment, a transmission of the first data unit set is not later than a transmission of the third message.

In one embodiment, a transmission of the first data unit set is later than a transmission of the third message.

In one embodiment, after receiving the fourth message, a data unit of the first radio bearer is used to generate a MAC subPDU at MAC sublayer, and a MAC subheader comprised in the MAC subPDU only indicates the first RLC bearer.

In one embodiment, after receiving the fourth message, a data unit of the first radio bearer is used to generate a MAC subPDU at MAC sublayer, and a MAC subheader comprised in the MAC subPDU only comprises the first logical channel identifier.

In one embodiment, after receiving the fourth message, a data unit of the first radio bearer is used to generate a MAC subPDU at MAC sublayer, and a MAC subheader comprised in the MAC subPDU does not comprise the first radio bearer identifier.

### Embodiment 6

Embodiment 6 illustrates a schematic diagram of a first RLC bearer, a second RLC bearer and a first radio bearer according to one embodiment of the present application, as shown in FIG. 6. In FIG. 6, the first RLC bearer and the second RLC bearer are associated with the first radio bearer; the slash-filled box indicates second RLC bearer failure.

In one embodiment, after monitoring the second RLC bearer failure, the second RLC bearer is still associated with the first radio bearer.

In one embodiment, after monitoring the second RLC bearer failure, the second RLC bearer is no longer used to transmit a data unit of the first radio bearer.

In one embodiment, after monitoring the second RLC bearer failure, the first radio bearer transmits the first data unit set through the first RLC bearer.

In one embodiment, after monitoring the second RLC bearer failure, the first radio bearer is self-configured as a PDCP duplication by the first node.

In one embodiment, after monitoring the second RLC bearer failure, the first radio bearer is self-configured as split bearer by the first node.

### Embodiment 7

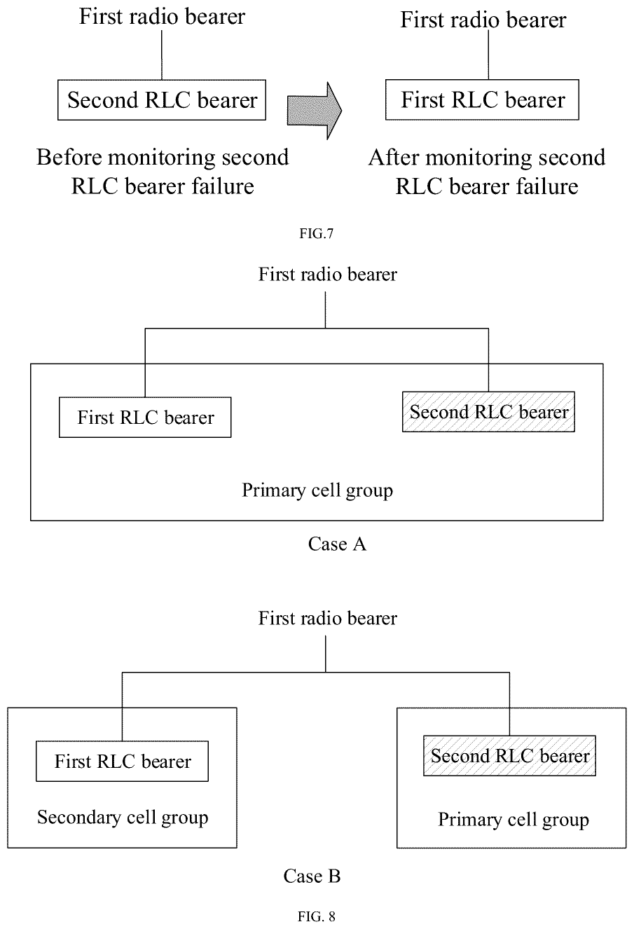

Embodiment 7 illustrates another schematic diagram of a first RLC bearer, a second RLC bearer and a first radio bearer according to one embodiment of the present application, as shown in FIG. 7. In FIG. 7, before monitoring the second RLC bearer failure, the second RLC bearer is associated with the first radio bearer; after monitoring the second RLC bearer failure, the first RLC bearer is associated with the first radio bearer.

In distinction to embodiment 6, after monitoring the second RLC bearer failure, the second RLC bearer is no longer associated with the first radio bearer.

In one embodiment, the third message is used to implicitly indicate that the second RLC bearer is no longer associated with the first radio bearer.

In one embodiment, the third message indicates that the first RLC bearer is associated with the first radio bearer, it also implicitly indicates that the second RLC bearer is no longer associated with the first radio bearer.

In one embodiment, the second RLC bearer no longer being associated with the first radio bearer comprises: releasing an RLC entity and a logical channel identifier comprised in the second RLC bearer.

In one embodiment, the second RLC bearer no longer being associated with the first radio bearer comprises: the first RLC bearer is a primary path.

### Embodiment 8

Embodiment 8 illustrates a schematic diagram of a first RLC bearer, a second RLC bearer, a first radio bearer and a cell group according to one embodiment of the present application, as shown in FIG. 8. In FIG. 8, the slash-filled box indicates second RLC bearer failure.

In one embodiment, at least one of serving cells allowed by the first RLC bearer does not belong to serving cells allowed by the second RLC bearer; herein, the first RLC bearer and the second RLC bearer belong to a same cell group.

In one subembodiment of the above embodiment, the cell group is a Master Cell Group (MCG).

In one embodiment, the above method effectively ensures a correct transmission of the first data unit set.

In one embodiment, the first RLC bearer and the second RLC bearer belong to different cell groups.

In one subembodiment of the above embodiment, the first RLC bearer belongs to a Secondary Cell Group (SCG), and the second RLC bearer belongs to a primary cell group.

In one subembodiment of the above embodiment, a serving cell allowed by the first RLC bearer is a cell in a secondary cell group, while a serving cell allowed by the second RLC bearer is a cell in a PCell.

In one embodiment, when the second RLC bearer is no longer associated with the first radio bearer, a secondary cell group to which the first RLC bearer belongs is automatically converted to a PCell group.

In one embodiment, partial RLC bearers in at least the first RLC bearer and the second RLC bearer belong to different cell groups; herein, the at least first RLC bearer comprises multiple RLC bearers.

In one subembodiment of the above embodiment, the partial RLC bearers in the at least first RLC bearer belong to a secondary cell group, and other partial RLC bearers in the at least first RLC bearer and the second RLC bearer belong to a PCell group.

In one embodiment, any one of serving cells allowed by the first RLC bearer does not belong to serving cells allowed by the second RLC bearer.

In one embodiment, the first processor, as a response to monitoring second RLC bearer failure, activates the first radio bearer as a split radio bearer.

Case A in FIG. 8 describes that the first RLC bearer and the second RLC bearer belong to a PCell group; Case B in FIG. 8 describes that the first RLC bearer belongs to a secondary cell group, and the second RLC bearer belongs to a PCell group.

In one embodiment, a maintenance base station of a PCell is an MgNB; and a maintenance base station of a secondary cell group is an SgNB.

### Embodiment 9

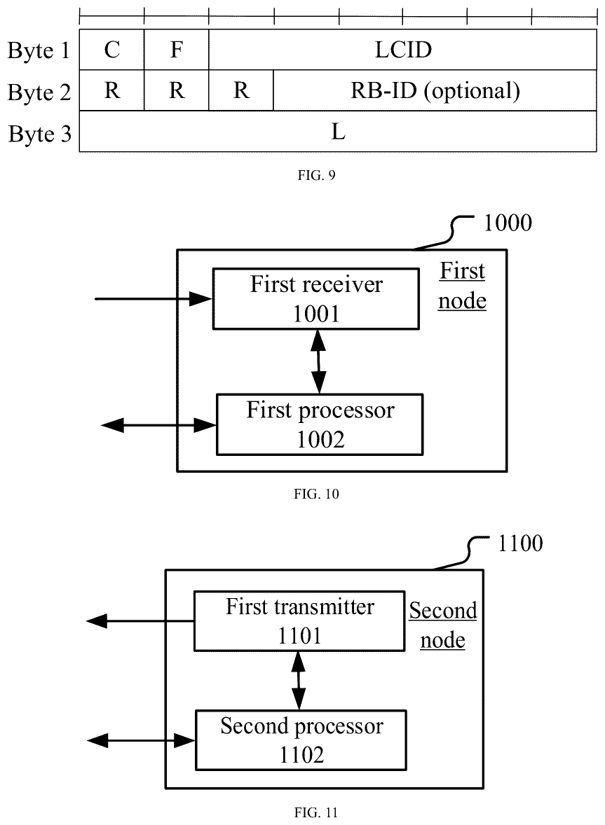

Embodiment 9 illustrates a schematic diagram of a format of a MAC subheader according to one embodiment of the present application, as shown in FIG. 9. A MAC subheader in FIG. 9 is applicable to a MAC subPDU generated by each data unit in the first data unit set at the MAC sublayer.

In embodiment 9, each data unit in the first data unit set is used to generate a MAC subPDU, the MAC subPDU comprises a MAC subheader, the MAC subheader comprises a first field, a second field and a third field, the first field indicates that there exists the second field, the second field indicates the first radio bearer; the third field indicates the first RLC bearer.

In one embodiment, a MAC subPDU generated by each data unit in the first data unit set comprises a MAC subheader and a MAC SDU.

In one embodiment, the MAC subheader comprises three bytes, which are byte 1, byte 2, and byte 3.

In one embodiment, the first field comprises C field.

In one embodiment, the first field is in byte 1, and the first field is a C field.

In one embodiment, the C field indicates whether the second field exists.

In one embodiment, a value of the C field being 1 indicates that the second field exists.

In one embodiment, a value of the C field being 0 indicates that the second field does not exist.

In one embodiment, the second field comprises an RB-ID field.

In one embodiment, the second field is in byte 2, and the second field is an RB-ID field.

In one embodiment, the RB-ID field indicates the first radio bearer.

In one embodiment, the RB-ID field comprises the first radio bearer identifier.

In one embodiment, the third field comprises an LCID field.

In one embodiment, the third field is in byte 1, and the third field is an LCID field.

In one embodiment, the LCID field indicates the first RLC bearer.

In one embodiment, the LCID field comprises the first logical channel identifier.

In one embodiment, the first RLC bearer associated with the first radio bearer is activated.

In one embodiment, the first RLC bearer associated with the first radio bearer is used to transmit a data unit of the first radio bearer.

In one embodiment, the first RLC bearer associated with the first radio bearer is used for PDCP duplication.

In one embodiment, the first RLC bearer associated with the first radio bearer is used for split secondary path.

In one embodiment, an R field in FIG. 9 represents a reserved bit, an F field in FIG. 9 represents a length of an L field, and the L field in the FIG. 9 represents a length of a MAC SDU corresponding to a MAC subheader.

In one embodiment, although not shown in FIG. 9, a reserved bit R can also indicate PDCP duplication or split bearer, for example, 0 represents PDCP duplication and 1 represents split bearer; when it indicates split bearer, a field indicating a data volume threshold can also be comprised.

It should be noted that location relations of a first field, a second field, and a third field in three bytes in FIG. 9 are only illustrated as examples and are not limited; for example, a first field can occupy a reserved bit in byte 2; a second field can occupy byte 3, which will not be repeated here.

### Embodiment 10

Embodiment 10 illustrates a structure block diagram of a processor in a first node according to one embodiment of the present application, as shown in FIG. 10.

In FIG. 10, a processor 1000 in a first node comprises a first receiver 1001 and a first processor 1002. The first node 1000 is a UE.

In embodiment 10, the first receiver 1001 receives a first message, and the first message is used to configure at least a first RLC bearer; receives a second message, the second message indicates that the at least first RLC bearer is a candidate of multiple radio bearers; monitors whether any RLC bearer in multiple RLC bearers is failed, and the multiple RLC bearers are associated with the multiple radio bearers; the first processor 1002, as a response to monitoring failure of a second RLC bearer, transmits a first data unit set through the first RLC bearer, the first data unit set belongs to a first radio bearer; the second RLC bearer is associated with the first radio bearer, and the first radio bearer is one of the multiple radio bearers; the second RLC bearer is one of the multiple RLC bearers; herein, the second message is an RRC-layer signaling; the first data unit set comprises at least one data unit.

In one embodiment, the first processor 1002 transmits a third message, the third message indicates the second RLC bearer failure; herein, the third message is an RRC message.

In one embodiment, the first processor 1002 transmits a third message, the third message indicates the second RLC bearer failure; herein, the third message is an RRC message; the first receiver 1001 receives a fourth message, the fourth message confirms that the first RLC bearer is associated with the first radio bearer; herein, the third message is used to trigger the fourth message; a transmission of the first data unit set is earlier than a reception of the fourth message.

In one embodiment, each data unit in the first data unit set being used to generate a MAC subPDU, the MAC subPDU comprising a MAC subheader, the MAC subheader comprising a first field, a second field and a third field, the first field indicating that there exists the second field, the second field indicating the first radio bearer; the third field indicating the first RLC bearer.

In one embodiment, at least one of serving cells allowed by the first RLC bearer does not belong to serving cells allowed by the second RLC bearer; herein, the first RLC bearer and the second RLC bearer belong to a same cell group.

In one embodiment, the first RLC bearer and the second RLC bearer belong to different cell groups.

In one embodiment, the first processor 1002 transmits a third message, the third message indicates the second RLC bearer failure; herein, the third message is an RRC message; the third message indicates the first RLC bearer.

In one embodiment, the first receiver 1001 comprises the receiver 454 (comprising the antenna 452), the receiving processor 456, the multi-antenna receiving processor 458 and the controller/processor 459 in FIG. 4 of the present application.

In one embodiment, the first receiver 1001 comprises at least one of the receiver 454 (comprising the antenna 452), the receiving processor 456, the multi-antenna receiving processor 458 or the controller/processor 459 in FIG. 4 of the present application.

In one embodiment, the first processor 1002 comprises the receiver 454 (comprising the antenna 452), the receiving processor 456, the multi-antenna receiving processor 458 and the controller/processor 459 in FIG. 4 of the present application.

In one embodiment, the first processor 1002 comprises at least one of the receiver 454 (comprising the antenna 452), the receiving processor 456, the multi-antenna receiving processor 458 or the controller/processor 459 in FIG. 4 of the present application.

In one embodiment, the first processor 1002 comprises the transmitter 454 (comprising the antenna 452), the transmitting processor 468, the multi-antenna transmitting processor 457 and the controller/processor 459 in FIG. 4 of the present application.

In one embodiment, the first processor 1002 comprises at least one of the transmitter 454 (comprising the antenna 452), the transmitting processor 468, the multi-antenna transmitting processor 457 or the controller/processor 459 in FIG. 4 of the present application.

In one embodiment, the first processor 1002 comprises the controller/processor 459 in FIG. 4 of the present application.

### Embodiment 11

Embodiment 11 illustrates a structure block diagram of a processor in a second node according to one embodiment of the present application, as shown in FIG. 11. In FIG. 11, a processor 1100 in a second node comprises a first transmitter 1101 and a second processor 1102; the second node 1100 is a base station.

In embodiment 11, the first transmitter 1101 transmits a first message, and the first message is used to configure at least a first RLC bearer; transmits a second message, the second message indicates that the at least first RLC bearer is a candidate of multiple radio bearers; herein, whether any RLC bearer in multiple RLC bearers is failed is monitored, and the multiple RLC bearers are associated with the multiple radio bearers; when second RLC bearer failure is monitored, a first data unit set is transmitted through the first RLC bearer, the first data unit set belongs to a first radio bearer; the second RLC bearer is associated with the first radio bearer, and the first radio bearer is one of the multiple radio bearers; the second RLC bearer is one of the multiple RLC bearers; the second message is an RRC-layer signaling; the first data unit set comprises at least one data unit.

In one embodiment, the second processor 1102 receives a third message, the third message indicates the second RLC bearer failure; herein, the third message is an RRC message.

In one embodiment, the second processor 1102 receives a third message, the third message indicates the second RLC bearer failure; herein, the third message is an RRC message; the first transmitter 1101 transmits a fourth message, the fourth message confirms that the first RLC bearer is associated with the first radio bearer; herein, the third message is used to trigger the fourth message; a transmission of the first data unit set is earlier than a reception of the fourth message.

In one embodiment, each data unit in the first data unit set being used to generate a MAC subPDU, the MAC subPDU comprising a MAC subheader, the MAC subheader comprising a first field, a second field and a third field, the first field indicating that there exists the second field, the second field indicating the first radio bearer; the third field indicating the first RLC bearer.

In one embodiment, at least one of serving cells allowed by the first RLC bearer does not belong to serving cells allowed by the second RLC bearer; herein, the first RLC bearer and the second RLC bearer belong to a same cell group.

In one embodiment, the first RLC bearer and the second RLC bearer belong to different cell groups.

In one embodiment, the second processor 1102 receives a third message, the third message indicates the second RLC bearer failure; herein, the third message is an RRC message; the third message indicates that the first RLC bearer.

In one embodiment, the first transmitter 1101 comprises the transmitter 418 (including the antenna 420), the transmitting processor 416, the multi-antenna transmitting processor 471 and controller/processor 475 in FIG. 4 of the present application.

In one embodiment, the first transmitter 1101 comprises at least one of the transmitter 418 (including the antenna 420), the transmitting processor 416, the multi-antenna transmitting processor 471 or the controller/processor 475 in FIG. 4 of the present application.

In one embodiment, the second processor 1102 comprises the transmitter 418 (including the antenna 420), the transmitting processor 416, the multi-antenna transmitting processor 471 and controller/processor 475 in FIG. 4 of the present application.

In one embodiment, the second processor 1102 comprises at least one of the transmitter 418 (including the antenna 420), the transmitting processor 416, the multi-antenna transmitting processor 471 or the controller/processor 475 in FIG. 4 of the present application.

In one embodiment, the second processor 1102 comprises the transmitter 418 (comprising the antenna 420), the receiving processor 470, the multi-antenna receiving processor 472 and the controller/processor 475 in FIG. 4 in the present application.

In one embodiment, the second processor 1102 comprises at least one of the transmitter 418 (comprising the antenna 420), the receiving processor 470, the multi-antenna receiving processor 472 or the controller/processor 475 in FIG. 4 in the present application.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. A first-type communication node or a UE or a terminal in the present application includes but not limited to mobile phones, tablet computers, laptops, network cards, low-power devices, enhanced Machine Type Communication (eMTC) devices, NB-IOT devices, vehicle-mounted communication equipment, aircrafts, airplanes, unmanned aerial vehicles (UAV), telecontrolled aircrafts and other wireless communication devices. The second-type communication node or the base station or the network side device in the present application includes but is not limited to the macro-cellular base stations, micro-cellular base stations, home base stations, relay base stations, eNB, gNB, Transmission and Reception Points (TRP), relay satellites, satellite base stations, air base stations, testing equipment, such as transceiver devices that simulate some functions of base stations, signaling testers and other wireless communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first message, the first message being used to configure at least a first RLC bearer; receiving a second message, the second message indicating that the at least first RLC bearer is a candidate of multiple radio bearers; monitoring whether any RLC bearer in multiple RLC bearers is failed, the multiple RLC bearers being associated with the multiple radio bearers; and
a first processor, as a response to monitoring failure of a second RLC bearer, transmitting a first data unit set through the first RLC bearer, the first data unit set belonging to a first radio bearer; the second RLC bearer being associated with the first radio bearer, and the first radio bearer being one of the multiple radio bearers; the second RLC bearer being one of the multiple RLC bearers;
wherein the second message is an RRC-layer signaling; the first data unit set comprises at least one data unit.

2. The first node according to claim 1, wherein each data unit in the first data unit set is used to generate a MAC subPDU, the MAC subPDU comprises a MAC subheader, the MAC subheader comprises a first field, a second field and a third field, the first field indicates that there exists the second field, and the second field indicates the first radio bearer; the third field indicates the first RLC bearer.

3. The first node according to claim 1, wherein at least one of serving cells allowed by the first RLC bearer does not belong to serving cells allowed by the second RLC bearer;
wherein the first RLC bearer and the second RLC bearer belong to a same cell group.

4. The first node according to claim 1, wherein the first RLC bearer and the second RLC bearer belong to different cell groups.

5. The first node according to claim 1, comprising:
the first processor, transmitting a third message, the third message indicating the second RLC bearer failure;
wherein the third message is an RRC message.

6. The first node according to claim 5, wherein the third message indicates the first RLC bearer.

7. The first node according to claim 5, comprising:
the first receiver, receiving a fourth message, the fourth message confirming that the first RLC bearer is associated with the first radio bearer;
wherein the third message is used to trigger the fourth message; a transmission of the first data unit set is earlier than a reception of the fourth message.

8. A second node for wireless communications, comprising:
a first transmitter, transmitting a first message, the first message being used to configure at least a first RLC bearer; transmitting a second message, the second message indicating that the at least first RLC bearer is a candidate of multiple radio bearers;
wherein whether any RLC bearer in multiple RLC bearers is failed is monitored, and the multiple RLC bearers are associated with the multiple radio bearers; when second RLC bearer failure is monitored, a first data unit set is transmitted through the first RLC bearer, the first data unit set belongs to a first radio bearer; the second RLC bearer is associated with the first radio bearer, and the first radio bearer is one of the multiple radio bearers; the second RLC bearer is one of the multiple RLC bearers; the second message is an RRC-layer signaling; the first data unit set comprises at least one data unit.

9. The second node according to claim 8, wherein each data unit in the first data unit set is used to generate a MAC subPDU, the MAC subPDU comprises a MAC subheader, the MAC subheader comprises a first field, a second field and a third field, the first field indicates that there exists the second field, and the second field indicates the first radio bearer; the third field indicates the first RLC bearer.

10. The second node according to claim 8, wherein at least one of serving cells allowed by the first RLC bearer does not belong to serving cells allowed by the second RLC bearer;
wherein the first RLC bearer and the second RLC bearer belong to a same cell group.

11. The second node according to claim 8, wherein the first RLC bearer and the second RLC bearer belong to different cell groups.

12. The second node according to claim 8, comprising:
a second processor, receiving a third message, the third message indicating the second RLC bearer failure;
wherein the third message is an RRC message.

13. The second node according to claim 12, comprising:
the first transmitter, transmitting a fourth message, the fourth message confirming that the first RLC bearer is associated with the first radio bearer;
wherein the third message is used to trigger the fourth message; a transmission of the first data unit set is earlier than a reception of the fourth message.

14. A method in a first node for wireless communications, comprising:
receiving a first message, the first message being used to configure at least a first RLC bearer;
receiving a second message, the second message indicating that the at least first RLC bearer is a candidate of multiple radio bearers; monitoring whether any RLC bearer in multiple RLC bearers is failed, the multiple RLC bearers being associated with the multiple radio bearers; and
as a response to monitoring failure of a second RLC bearer, transmitting a first data unit set through the first RLC bearer, the first data unit set belonging to a first radio bearer; the second RLC bearer being associated with the first radio bearer, and the first radio bearer being one of the multiple radio bearers; the second RLC bearer being one of the multiple RLC bearers;
wherein the second message is an RRC-layer signaling; the first data unit set comprises at least one data unit.

15. The method in a first node according to claim 14, wherein each data unit in the first data unit set is used to generate a MAC subPDU, the MAC subPDU comprises a MAC subheader, the MAC subheader comprises a first field, a second field and a third field, the first field indicates that there exists the second field, and the second field indicates the first radio bearer; the third field indicates the first RLC bearer.

16. The method in a first node according to claim 14, wherein at least one of serving cells allowed by the first RLC bearer does not belong to serving cells allowed by the second RLC bearer;
wherein the first RLC bearer and the second RLC bearer belong to a same cell group.

17. The method in a first node according to claim 14, wherein the first RLC bearer and the second RLC bearer belong to different cell groups.

18. The method in a first node according to claim 14, comprising:
transmitting a third message, the third message indicating the second RLC bearer failure;
wherein the third message is an RRC message.

19. The method in a first node according to claim 18, wherein the third message indicates the first RLC bearer.

20. The method in a first node according to claim 18, comprising:
receiving a fourth message, the fourth message confirming that the first RLC bearer is associated with the first radio bearer;
wherein the third message is used to trigger the fourth message; a transmission of the first data unit set is earlier than a reception of the fourth message.
